(19) United States
(12) Patent Application Publication
(10) Pub. No.: US 2024/0283013 A1
(43) Pub. Date: Aug. 22, 2024

(54) SOLID ELECTROLYTE MATERIAL AND BATTERY

(71) Applicant: Panasonic Intellectual Property Management Co., Ltd., Osaka (JP)

(72) Inventors: Yui MASUMOTO, Osaka (JP); Yoshimasa NAKAMA, Osaka (JP)

(21) Appl. No.: 18/643,698

(22) Filed: Apr. 23, 2024

Related U.S. Application Data
(63) Continuation of application No. PCT/JP2022/033806, filed on Sep. 8, 2022.

(30) Foreign Application Priority Data
Oct. 28, 2021 (JP) 2021-176885

(51) Int. Cl. H01M 10/0562

(52) U.S. Cl. CPC H01M 10/0562; H01M 2300/008

(57) ABSTRACT

A solid electrolyte material of the present disclosure includes Li, Nb, M, and F. The M is at least one selected from the group consisting of Be, Mg, Ca, Sr, Ba, Sc, Y, Al, Ga, In, Zr, and Sn. A battery of the present disclosure includes a positive electrode, a negative electrode, and an electrolyte layer disposed between the positive electrode and the negative electrode. At least one selected from the group consisting of the positive electrode, the negative electrode, and the electrolyte layer includes the solid electrolyte material of the present disclosure.

This application is a continuation of PCT/JP2022/033806 filed on Sep. 8, 2022, which claims foreign priority of Japanese Patent Application No. 2021-176885 filed on Oct. 28, 2021, the entire contents of both of which are incorporated herein by reference.

### BACKGROUND OF THE INVENTION

### 1. Field of the Invention

The present disclosure relates to a solid electrolyte material and a battery.

### 2. Description of Related Art

JP 2006-244734 A discloses a battery in which a solid electrolyte includes In as a cation and a halogen element, such as Cl, Br, or I, as an anion.

### SUMMARY OF THE INVENTION

The present disclosure aims to provide a novel halide solid electrolyte material.

A solid electrolyte material according to one aspect of the present disclosure includes:

Li, Nb, M, and F, wherein the M is at least one selected from the group consisting of Be, Mg, Ca, Sr, Ba, Sc, Y, Al, Ga, In, Zr, and Sn.

According to the present disclosure, it is possible to provide a novel halide solid electrolyte material.

### BRIEF DESCRIPTION OF THE DRAWINGS

FIG. 1 is a cross-sectional view schematically showing the configuration of a battery of Embodiment 2.

FIG. 2 is a cross-sectional view schematically showing the configuration of a battery of Embodiment 3.

FIG. 3 is a schematic diagram of a pressure-molding die for use in evaluating the ionic conductivity of solid electrolyte materials.

FIG. 4 is a graph showing a Cole-Cole plot obtained by impedance measurement on a solid electrolyte material of Example 1.

FIG. 5 is a graph showing the initial discharge characteristics of a battery of Example 1.

### DETAILED DESCRIPTION

### (Findings Underlying the Present Disclosure)

JP 2006-244734 A discloses an all-solid-state lithium secondary battery in which a solid electrolyte consists of a compound including In as a cation and a halogen element, such as Cl, Br, or I, as an anion. This battery is described as exhibiting favorable charge and discharge characteristics owing to its positive electrode active material having an average potential of 3.9 V or less versus Li. The above disclosure provides a description that setting the potential of the positive electrode active material versus Li to the above value can suppress the formation of a coating formed of an oxidative decomposition product, thereby enabling the battery to exhibit favorable charge and discharge characteristics. JP 2006-244734 A also discloses, as positive electrode active materials having an average potential of 3.9 V or less versus Li, typical layered transition metal oxides, such as LiCoO₂ and LiNi_{0.8}Co_{0.15}Al_{0.05}O₂.

Meanwhile, the present inventors have made extensive studies on the resistance of halide solid electrolytes to oxidative decomposition. As a result, the present inventors have found that solid electrolytes exhibit various levels of resistance to oxidative decomposition depending on the types of elements contained as anions. Here, halide solid electrolytes are solid electrolytes containing a halogen element, such as F, Cl, Br, or I, as an anion.

Specifically, the present inventors have found that using, in a positive electrode material, a halide solid electrolyte including one selected from the group consisting of Cl, Br and I causes oxidative decomposition of the halide solid electrolyte during charge even with use of a positive electrode active material having an average potential of 3.9 V or less versus Li. The present inventors have also found that oxidative decomposition of such a halide solid electrolyte as above forms an oxidative decomposition product serving as a resistance layer, thus increasing the internal resistance of the battery during charge. This problem of increasing the internal resistance of the battery during charge is inferred to be due to the oxidation reaction of one element, which is selected from the group consisting of Cl, Br and I, included in the halide solid electrolyte. The oxidation reaction used herein refers to a side reaction that occurs in addition to a normal charge reaction in which lithium ions and electrons are extracted from the positive electrode active material included in the positive electrode material. In the side reaction, electrons are extracted also from the halide solid electrolyte including the one element, which is selected from the group consisting of Cl, Br and I, in contact with the positive electrode active material. The halogen element has a relatively large ionic radius, and has a small interaction force with a cationic component of the halide solid electrolyte. Probably because of this fact, the halide solid electrolyte is prone to an oxidation reaction. This oxidation reaction forms, between the positive electrode active material and the halide solid electrolyte, an oxidative decomposition layer having a poor lithium-ion conductivity. This oxidative decomposition layer serves as a high interfacial resistance in the electrode reaction of the positive electrode. This probably increases the internal resistance of the battery during charge.

The present inventors have further found that a battery in which a halide solid electrolyte including fluorine (F) is used in a positive electrode material exhibits an excellent oxidation resistance and accordingly can suppress an increase in the internal resistance of the battery during charge. Although not elucidated, the details of the mechanism are inferred as follows. F has the highest electronegativity among the halogen elements. In a halide solid electrolyte including F, F strongly bonds to the cation. This makes the halide solid electrolyte to be less prone to the progress with the oxidation reaction of F, namely, the side reaction in which electrons are extracted from F.

On the basis of the above findings, the present inventors have arrived at the solid electrolyte material of the present disclosure.

### (Overview of One Aspect According to the Present Disclosure)

A solid electrolyte material according to a first aspect of the present disclosure includes: Li, Nb, M, and F, wherein

the M is at least one selected from the group consisting of Be, Mg, Ca, Sr, Ba, Sc, Y, Al, Ga, In, Zr, and Sn.

The solid electrolyte material according to the first aspect can have a high oxidation resistance by including F, which has a high oxidation-reduction potential. Meanwhile, solid electrolyte materials including Li and F generally tend to have a low ionic conductivity. The solid electrolyte material according to the first aspect, however, can have a high ionic conductivity by including Nb and M in addition to Li and F. With the above configuration, it is therefore possible to provide a novel halide solid electrolyte material having a high oxidation resistance and a high ionic conductivity.

In a second aspect of the present disclosure, for example, the solid electrolyte material according to the first aspect may be such that a ratio of an amount of substance of the Li to a sum of amounts of substance of the Nb and the M is 2.2 or more and 3.3 or less.

With the above configuration, it is possible to further enhance the ionic conductivity.

In a third aspect of the present disclosure, for example, the solid electrolyte material according to the first or second aspect may be such that the solid electrolyte material is represented by the following composition formula (1):

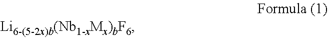

in the composition formula (1), the M is Al, and 0<x<1 and 0<b≤1.2 are satisfied.

With the above configuration, it is possible to further enhance the ionic conductivity.

In a fourth aspect of the present disclosure, for example, the solid electrolyte material according to the third aspect may be such that in the composition formula (1), 0.40≤x≤0.80 is satisfied.

With the above configuration, it is possible to further enhance the ionic conductivity.

In a fifth aspect of the present disclosure, for example, the solid electrolyte material according to the third or fourth aspect may be such that in the composition formula (1), 0.80≤b≤1.10 is satisfied.

With the above configuration, it is possible to further enhance the ionic conductivity.

A battery according to a sixth aspect of the present disclosure includes:
a positive electrode; a negative electrode; and an electrolyte layer disposed between the positive electrode and the negative electrode, wherein
at least one selected from the group consisting of the positive electrode, the negative electrode, and the electrolyte layer includes the solid electrolyte material according to any one of the first to fifth aspects.

With the above configuration, the battery can have excellent charge and discharge characteristics.

In a seventh aspect of the present disclosure, for example, the battery according to the sixth aspect may be such that the electrolyte layer includes a first electrolyte layer and a second electrolyte layer, the first electrolyte layer is disposed between the positive electrode and the negative electrode, the second electrolyte layer is disposed between the first electrolyte layer and the negative electrode, and the first electrolyte layer includes the solid electrolyte material.

With the above configuration, the battery can have further enhanced charge and discharge characteristics.

Embodiments of the present disclosure will be described below with reference to the drawings.

### Embodiment 1

A solid electrolyte material of Embodiment 1 includes Li, Nb, M, and F. M is at least one selected from the group consisting of Be, Mg, Ca, Sr, Ba, Sc, Y, Al, Ga, In, Zr, and Sn.

The solid electrolyte material of Embodiment 1 can have a high oxidation resistance by including F, which has a high oxidation-reduction potential. Meanwhile, F has a high electronegativity, and accordingly has a relatively strong bond with Li. Consequently, solid electrolyte materials including Li and F generally tend to have a low ionic conductivity. For example, LiBF₄ disclosed in JP 2006-244734 A has an ionic conductivity of 6.7×10⁻⁹ S/cm. The solid electrolyte material of Embodiment 1, however, can have a high ionic conductivity of, for example, 4×10⁻⁷ S/cm or more by further including Nb and M in addition to Li and F. With the above configuration, it is therefore possible to provide a novel halide solid electrolyte material having a high oxidation resistance and a high ionic conductivity.

The solid electrolyte material may include an anion other than F. Examples of the anion include Cl, Br, I, O, S, and Se. With the above configuration, it is possible to further enhance the ionic conductivity.

The solid electrolyte material may consist substantially of Li, Nb, M, and F. Here, the phrase “the solid electrolyte material consists substantially of Li, Nb, M, and F” means that the ratio (i.e., mole fraction) of the sum of the amounts of substance of Li, Nb, M, and F to the total of the amounts of substance of all the elements constituting the solid electrolyte material of Embodiment 1 is 90% or more. In an example, the ratio (i.e., mole fraction) may be 95% or more.

The solid electrolyte material may consist of Li, Nb, M, and F.

The solid electrolyte material may contain an element unavoidably incorporated. Examples of the element include hydrogen, oxygen, and nitrogen. Such an element can be included in the raw material powder of the solid electrolyte material or present in an atmosphere for manufacturing or storing the solid electrolyte material.

In the solid electrolyte material, the ratio of the amount of substance of Li to the sum of the amounts of substance of Nb and M may be 2.2 or more and 3.3 or less, and may be 2.5 or more and 3.0 or less. With the above configuration, it is possible to further enhance the ionic conductivity.

In the solid electrolyte material, M may be at least one selected from the group consisting of Y and Al. With the above configuration, it is possible to further enhance the ionic conductivity.

The solid electrolyte material may be represented by the following composition formula (1):

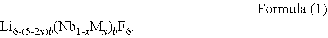

In the composition formula (1), M is Al, and 0<x<1 and 0<b≤1.2 are satisfied. With the above configuration, it is possible to further enhance the ionic conductivity.

In the composition formula (1), 0.40≤x<0.80 may be satisfied, and 0.50<x≤0.65 may be satisfied. With the above configuration, it is possible to further enhance the ionic conductivity.

In the composition formula (1), 0.80≤b≤1.10 may be satisfied, and 0.86≤b≤0.95 may be satisfied. With the above configuration, it is possible to further enhance the ionic conductivity.

The solid electrolyte material may be free of sulfur. The above configuration can prevent the generation of hydrogen sulfide gas. Therefore, it is possible to achieve a battery having an enhanced safety.

The solid electrolyte material may be crystalline or may be amorphous.

The shape of the solid electrolyte material is not limited. Examples of the shape of the solid electrolyte material include an acicular shape, a spherical shape, and an ellipsoidal shape. The solid electrolyte material may be particulate. The solid electrolyte material may be formed in the form of a pellet or a plate.

In the case where the solid electrolyte material is, for example, particulate (e.g., spherical), the solid electrolyte material may have a median diameter of 0.1 μm or more and 100 μm or less.

In the present disclosure, the median diameter means the particle diameter at a cumulative volume equal to 50% in the volumetric particle size distribution. The volumetric particle size distribution is measured with, for example, a laser diffractometer or an image analyzer.

The solid electrolyte material may have a median diameter of 0.5 μm or more and 10 μm or less. With the above configuration, it is possible to further enhance the ionic conductivity. Furthermore, in the case where the solid electrolyte material is mixed with a different material such as an active material, a favorable dispersion state of the solid electrolyte material and the different material is achieved.

### <Method for Manufacturing Solid Electrolyte Material>

The solid electrolyte material of Embodiment 1 can be manufactured by, for example, the following method.

Raw material powders are prepared and mixed together so as to obtain a target composition. The raw material powders may be, for example, halides.

In an example where the target composition is Li_{3.0}Nb_{0.5}Al_{0.5}F_{7.0}, LiF, NbF₅, and AlF₃ are mixed in an approximate molar ratio of 3.0:0.5:0.5. The raw material powders may be mixed in a molar ratio adjusted in advance so as to cancel out a composition change that can occur in the synthesis process.

The raw material powders are reacted with each other mechanochemically (i.e., by mechanochemical milling) in a mixer such as a planetary ball mill to obtain a reactant. The reactant may be fired in a vacuum or in an inert atmosphere. Alternatively, the mixture of the raw material powders may be fired in a vacuum or in an inert atmosphere to obtain a reactant. The firing may be conducted, for example, at 100° C. or higher and 300° C. or lower for 1 hour or longer. To suppress a composition change during the firing, the raw material powders may be fired in a sealed container such as a quartz tube.

The solid electrolyte material of Embodiment 1 is thus obtained.

### Embodiment 2

Embodiment 2 will be described below. The description overlapping that of Embodiment 1 will be omitted as appropriate.

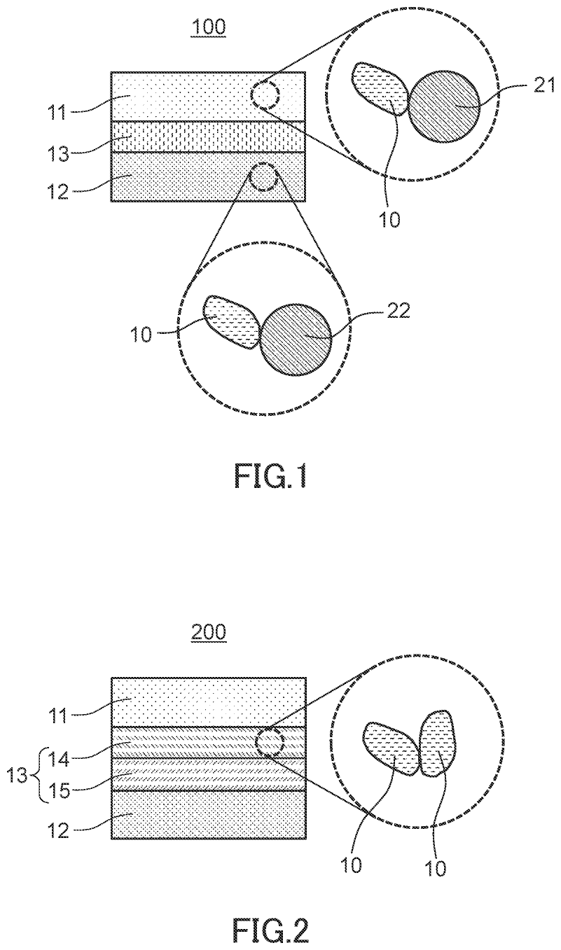

FIG. 1 is a cross-sectional view schematically showing the configuration of a battery 100 of Embodiment 2.

The battery 100 includes a positive electrode 11, a negative electrode 12, and an electrolyte layer 13. The electrolyte layer 13 is disposed between the positive electrode 11 and the negative electrode 12. At least one selected from the group consisting of the positive electrode 11, the negative electrode 12, and the electrolyte layer 13 includes a solid electrolyte material 10. The solid electrolyte material 10 includes the solid electrolyte material of Embodiment 1.

The solid electrolyte material 10 may be in the form of particles consisting of the solid electrolyte material of Embodiment 1, or may be in the form of particles including the solid electrolyte material of Embodiment 1 as its main component. Here, the particles including the solid electrolyte material of Embodiment 1 as its main component mean particles in which the component contained in the largest amount in terms of mass ratio is the solid electrolyte material of Embodiment 1.

The battery 100 includes the solid electrolyte material 10, and accordingly can have excellent charge and discharge characteristics.

The battery 100 may be an all-solid-state battery. The all-solid-state battery may be a primary battery or may be a secondary battery.

In the present embodiment, the positive electrode 11 includes a positive electrode active material 21 and the solid electrolyte material 10.

In the positive electrode 11, the positive electrode active material 21 and the solid electrolyte material 10 may be in contact with each other. The positive electrode 11 may include a plurality of particles of the positive electrode active material 21 and a plurality of particles of the solid electrolyte material 10.

The positive electrode 11 includes a material having properties of occluding and releasing metal ions. The material is, for example, the positive electrode active material 21. The metal ions are typically lithium ions.

Examples of the positive electrode active material 21 include a lithium-containing transition metal oxide, a transition metal fluoride, a polyanion material, a fluorinated polyanion material, a transition metal sulfide, a transition metal oxysulfide, and a transition metal oxynitride. Examples of the lithium-containing transition metal oxide include Li(Ni, Co, Al)O₂, Li(Ni, Co,Mn)O₂, and LiCoO₂.

In the present disclosure, when an element in a formula is expressed as, for example, “(Ni, Co, Al)”, this expression indicates at least one element selected from the group of elements in parentheses. That is, “(Ni, Co, Al)” is synonymous with “at least one selected from the group consisting of Ni, Co, and Al”. The same applies to other elements.

The positive electrode active material 21 may have a median diameter of 0.1 μm or more and 100 μm or less. In the case where the positive electrode active material 21 has a median diameter of 0.1 μm or more, a favorable dispersion state of the positive electrode active material 21 and the solid electrolyte material 10 is achieved in the positive electrode 11. The above configuration enhances the charge and discharge characteristics of the battery 100. In the case where the positive electrode active material 21 has a median diameter of 100 μm or less, the diffusion rate of lithium inside the positive electrode active material 21 is enhanced. The above configuration enables the battery 100 to operate at a high output.

The positive electrode active material 21 may have a larger median diameter than the solid electrolyte material 10 has. The above configuration achieves a favorable dispersion state of the positive electrode active material 21 and the solid electrolyte material 10 in the positive electrode 11.

In the positive electrode 11, the ratio of the volume of the positive electrode active material 21 to the sum of the volume of the positive electrode active material 21 and the volume of the solid electrolyte material 10 may be 0.30 or more and 0.95 or less. The above configuration enhances the energy density and output of the battery 100.

On at least a portion of the surface of the positive electrode active material 21, a coating layer may be formed. For example, before mixing of the positive electrode active material 21 with a conductive additive and a binder, the coating layer can be formed on the surface of the positive electrode active material 21. Examples of the coating material included in the coating layer include a sulfide solid electrolyte, an oxide solid electrolyte, and a halide solid electrolyte. In the case where the solid electrolyte material 10 includes a sulfide solid electrolyte, the coating material may include the solid electrolyte material of Embodiment 1 in order to suppress oxidative decomposition of the sulfide solid electrolyte. In the case where the solid electrolyte material 10 includes the solid electrolyte material of Embodiment 1, the coating material may include an oxide solid electrolyte in order to suppress oxidative decomposition of the solid electrolyte material. The oxide solid electrolyte may be lithium niobate, which is excellent in high-potential stability. Suppressing oxidative decomposition of the solid electrolyte material can suppress an increase in the overvoltage of the battery 100.

The positive electrode 11 may have a thickness of 10 μm or more and 500 μm or less. The above configuration enhances the energy density and output of the battery 100.

In the present embodiment, the negative electrode 12 includes a negative electrode active material 22 and the solid electrolyte material 10.

In the negative electrode 12, the negative electrode active material 22 and the solid electrolyte material 10 may be in contact with each other. The negative electrode 12 may include a plurality of particles of the negative electrode active material 22 and a plurality of particles of the solid electrolyte material 10.

The negative electrode 12 includes a material having properties of occluding and releasing metal ions. The material is, for example, the negative electrode active material 22. The metal ions are typically lithium ions.

Examples of the negative electrode active material 22 include a metal material, a carbon material, an oxide, a nitride, a tin compound, and a silicon compound. The metal material may be a simple substance of metal or may be an alloy. Examples of the metal material include lithium metal and a lithium alloy. Examples of the carbon material include natural graphite, coke, partially graphitized carbon, a carbon fiber, spherical carbon, artificial graphite, and amorphous carbon. From the viewpoint of capacity density, suitable examples of the negative electrode active material include silicon (i.e., Si), tin (i.e., Sn), a silicon compound, and a tin compound.

The negative electrode active material 22 may be selected in view of the reduction resistance of the solid electrolyte material included in the negative electrode 12. For example, in the case where the negative electrode 12 includes the solid electrolyte material of Embodiment 1 as the solid electrolyte material 10, the negative electrode active material 22 may be a material having properties of occluding and releasing lithium ions at 0.27 V or more versus lithium. Examples of such a material as the negative electrode active material 22 include a titanium oxide, an indium metal, and a lithium alloy. Examples of the titanium oxide include Li₄Ti₅O₁₂, LiTi₂O₄, and TiO₂. In the case where such a material is used as the negative electrode active material 22, it is possible to suppress reductive decomposition of the solid electrolyte material included in the negative electrode 12. Therefore, the charge and discharge efficiency of the battery 100 can be enhanced.

The negative electrode active material 22 may have a median diameter of 0.1 μm or more and 100 μm or less. In the case where the negative electrode active material 22 has a median diameter of 0.1 μm or more, a favorable dispersion state of the negative electrode active material 22 and the solid electrolyte material 10 is achieved in the negative electrode 12. The above configuration enhances the charge and discharge characteristics of the battery 100. In the case where the negative electrode active material 22 has a median diameter of 100 μm or less, the diffusion rate of lithium inside the negative electrode active material 22 is enhanced. The above configuration enables the battery 100 to operate at a high output.

The negative electrode active material 22 may have a larger median diameter than the solid electrolyte material 10 has. The above configuration achieves a favorable dispersion state of the negative electrode active material 22 and the solid electrolyte material 10 in the negative electrode 12.

In the negative electrode 12, the ratio of the volume of the negative electrode active material 22 to the sum of the volume of the negative electrode active material 22 and the volume of the solid electrolyte material 10 may be 0.30 or more and 0.95 or less. The above configuration enhances the energy density and output of the battery 100.

In the present embodiment, the electrolyte layer 13 includes an electrolyte material. The electrolyte material is, for example, a solid electrolyte material. The solid electrolyte material that can be included in the electrolyte layer 13 may include the solid electrolyte material of Embodiment 1.

The solid electrolyte material of Embodiment 1 is hereinafter referred to as a “first solid electrolyte material”. A solid electrolyte material different from the solid electrolyte material of Embodiment 1 is hereinafter referred to as a “second solid electrolyte material”. Examples of the second solid electrolyte material include Li₂MgX₄, LizFeX₄, Li(Al, Ga, In)X₄, Li₃(Al, Ga, In)X₆, and LiI, where X is at least one selected from the group consisting of F, Cl, Br, and I.

The electrolyte layer 13 may consist of the first solid electrolyte material. The electrolyte layer 13 may consist of the second solid electrolyte material.

The electrolyte layer 13 may include the first solid electrolyte material and the second solid electrolyte material. In the electrolyte layer 13, the first solid electrolyte material and the second solid electrolyte material may be dispersed uniformly. A layer made of the first solid electrolyte material and a layer made of the second solid electrolyte material may be stacked along the stacking direction for the battery 100.

In the present embodiment, the electrolyte layer 13 is in contact with the positive electrode 11 and the negative electrode 12.

The electrolyte layer 13 may have a thickness of 1 μm or more and 1000 μm or less. The above configuration enhances the energy density and output of the battery 100.

At least one selected from the group consisting of the positive electrode 11, the negative electrode 12, and the electrolyte layer 13 may include the second solid electrolyte material for the purpose of enhancing the ionic conductivity, chemical stability, and electrochemical stability.

The second solid electrolyte material may be a sulfide solid electrolyte.

Examples of the sulfide solid electrolyte include Li₂S—P₂S₅, Li₂S—SiS₂, Li₂S—B₂S₃, Li₂S—GeS₂, Li_{3.25}Ge_{0.25}P_{0.75}S₄, and Li₁₀GeP₂S₁₂. Furthermore, LiX, Li₂O, MO_{q}, LiₚMO_{q}, or the like may be added to the above sulfide solid electrolytes. Here, X is at least one selected from the group consisting of F, Cl, Br, and I. Moreover, M is at least one selected from the group consisting of P, Si, Ge, B, Al, Ga, In, Fe, and Zn. The symbols p and q are each a natural number. One or two or more sulfide solid electrolytes selected from the above materials can be used.

In the case where the electrolyte layer 13 includes the first solid electrolyte material, the negative electrode 12 may include a sulfide solid electrolyte in order to suppress reductive decomposition of the first solid electrolyte material. By coating the negative electrode active material 22 with the sulfide solid electrolyte, which is electrochemically stable, it is possible to suppress contact of the first solid electrolyte material included in the electrolyte layer 13 with the negative electrode active material 22. Therefore, the internal resistance of the battery 100 can be reduced.

The second solid electrolyte material may be an oxide solid electrolyte.

The oxide solid electrolyte can be, for example: a NASICON solid electrolyte typified by LiTi₂(PO₄)₃ and element-substituted substances thereof; a (LaLi)TiO₃-based perovskite solid electrolyte; a LISICON solid electrolyte typified by Li₁₄ZnGe₄O₁₆, Li₄SiO₄, and LiGeO₄ and element-substituted substances thereof; a garnet solid electrolyte typified by Li₇La₃Zr₂O₁₂ and element-substituted substances thereof; Li₃PO₄ and N-substituted substances thereof; or glass or glass ceramics based on a Li—B—O compound, such as LiBO₂ or LisBO₃, to which Li₂SO₄, Li₂CO₃, or the like is added. One or two or more oxide solid electrolyte selected from the above materials can be used.

As described above, the second solid electrolyte material may be a halide solid electrolyte.

Examples of the halide solid electrolyte include Li₂MgX₄, Li₂FeX₄, Li(Al, Ga, In)X₄, Li₃(Al, Ga, In)X₆, and LiI, where X is at least one selected from the group consisting of F, Cl, Br, and I.

Another example of the halide solid electrolyte is a compound represented by LiₐMe_{b}Y_{c}X₆, where a+mb+3c=6 and c>0 are satisfied, Me is at least one selected from the group consisting of metalloid elements and metal elements other than Li or Y, and m represents the valence of Me.

In the present disclosure, the “metalloid elements” refer to B, Si, Ge, As, Sb, and Te. The “metal elements” refer to all the elements included in Groups 1 to 12 of the periodic table (except hydrogen) and all the elements included in Groups 13 to 16 of the periodic table (except B, Si, Ge, As, Sb, Te, C, N, P, O, S, and Se). That is, the “metalloid elements” and the “metal elements” are each a group of elements that can become a cation when forming an inorganic compound together with a halogen element.

To enhance the ionic conductivity of the halide solid electrolyte, Me may be at least one selected from the group consisting of Mg, Ca, Sr, Ba, Zn, Sc, Al, Ga, Bi, Zr, Hf, Ti, Sn, Ta, and Nb. The halide solid electrolyte may be Li₃YCl₆ or Li₃YBr₆.

The second solid electrolyte material may be a polymer solid electrolyte.

The polymer solid electrolyte can be, for example, a compound of a polymer compound and a lithium salt. The polymer compound may have an ethylene oxide structure. The polymer compound having an ethylene oxide structure can contain a lithium salt in a large amount. Accordingly, the ionic conductivity can be further enhanced. The lithium salt can be LiPF₆, LiBF₄, LiSbF₆, LiAsF₆, LiSO₃CF₃, LIN(SO₂F)₂, LIN(SO₂CF₃)₂, LiN(SO₂C₂F₅)₂, LIN(SO₂CF₃)(SO₂C₄F₉), LiC(SO₂CF₃)₃, or the like. The lithium salts may be used alone or in combination.

At least one selected from the group consisting of the positive electrode 11, the negative electrode 12, and the electrolyte layer 13 may include a nonaqueous electrolyte solution, a gel electrolyte, or an ionic liquid. The above configuration facilitates the transfer of lithium ions. Therefore, the battery 100 can have enhanced output characteristics.

The nonaqueous electrolyte solution includes a nonaqueous solvent and a lithium salt dissolved in the nonaqueous solvent.

The nonaqueous solvent can be a cyclic carbonate solvent, a chain carbonate solvent, a cyclic ether solvent, a chain ether solvent, a cyclic ester solvent, a chain ester solvent, a fluorinated solvent, or the like. Examples of the cyclic carbonate solvent include ethylene carbonate, propylene carbonate, and butylene carbonate. Examples of the chain carbonate solvent include dimethyl carbonate, ethyl methyl carbonate, and diethyl carbonate. Examples of the cyclic ether solvent include tetrahydrofuran, 1,4-dioxane, and 1,3-dioxolane. Examples of the chain ether solvent include 1,2-dimethoxyethane and 1,2-diethoxyethane. Examples of the cyclic ester solvent include γ-butyrolactone. Examples of the chain ester solvent include methyl acetate. Examples of the fluorinated solvent include fluoroethylene carbonate, methyl fluoropropionate, fluorobenzene, fluoroethylmethyl carbonate, and fluorodimethylene carbonate. One nonaqueous solvent selected from the above may be used alone, or a mixture of two or more nonaqueous solvents selected from the above may be used.

The lithium salt can be LiPF₆, LiBF₄, LiSbF₆, LiAsF₆, LiSO₃CF₃, LIN(SO₂CF₃)₂, LIN(SO₂C₂F₅)₂, LIN(SO₂CF₃)(SO₂C₄F₉), LiC(SO₂CF₃)₃, or the like. One lithium salt selected from the above may be used alone, or a mixture of two or more lithium salts selected from the above may be used. The lithium salt has a concentration of, for example, 0.5 mol/L or more and 2 mol/L or less.

The gel electrolyte can be a polymer material impregnated with a nonaqueous electrolyte solution. Examples of the polymer material include polyethylene oxide, polyacrylonitrile, polyvinylidene fluoride, polymethylmethacrylate, and a polymer having an ethylene oxide bond.

Examples of the cation contained in the ionic liquid include: an aliphatic chain quaternary salt, such as tetraalkylammonium or tetraalkylphosphonium; an aliphatic cyclic ammonium, such as pyrrolidinium, morpholinium, imidazolinium, tetrahydropyrimidinium, piperazinium, or piperidinium; and a nitrogen-containing heterocyclic aromatic cation, such as pyridinium or imidazolium.

Examples of the anion contained in the ionic liquid include PF₆⁻, BF₄, SbF₆³¹, AsF₆⁻, SO₃CF₃⁻, N(SO₂CF₃)₂⁻, N(SO₂C₂F₅)₂⁻, N(SO₂CF₃)(SO₂C₄F₉)⁻, and C(SO₂CF₃)₃⁻.

The ionic liquid may include a lithium salt.

At least one selected from the group consisting of the positive electrode 11, the negative electrode 12, and the electrolyte layer 13 may include a binder for the purpose of enhancing the adhesion between the particles.

Examples of the binder include polyvinylidene fluoride, polytetrafluoroethylene, polyethylene, polypropylene, an aramid resin, a polyamide, a polyimide, a polyamideimide, polyacrylonitrile, a polyacrylic acid, polyacrylic acid methyl ester, polyacrylic acid ethyl ester, polyacrylic acid hexyl ester, a polymethacrylic acid, polymethacrylic acid methyl ester, polymethacrylic acid ethyl ester, polymethacrylic acid hexyl ester, polyvinyl acetate, polyvinylpyrrolidone, a polyether, a polyethersulfone, hexafluoropolypropylene, styrene-butadiene rubber, and carboxymethyl cellulose. The binder can also be a copolymer. Such a binder can be, for example, a copolymer of two or more materials selected from the group consisting of tetrafluoroethylene, hexafluoroethylene, hexafluoropropylene, perfluoroalkyl vinyl ether, vinylidene fluoride, chlorotrifluoroethylene, ethylene, propylene, pentafluoropropylene, fluoromethyl vinyl ether, acrylic acid, and hexadiene. The binder may be a mixture of two or more materials selected from the above.

At least one selected from the group consisting of the positive electrode 11 and the negative electrode 12 may include a conductive additive in order to reduce the electronic resistance.

The conductive additive can be, for example, graphite, such as natural graphite or artificial graphite, carbon black, such as acetylene black or Ketjenblack, a conductive fiber, such as a carbon fiber or a metal fiber, fluorinated carbon, a metal powder, such as an aluminum powder, a conductive whisker, such as a zinc oxide whisker or a potassium titanate whisker, a conductive metal oxide, such as titanium oxide, or a conductive polymer compound, such as a polyaniline compound, a polypyrrole compound, or a polythiophene compound. In the case where a conductive carbon additive is used as the conductive additive, cost reduction can be achieved.

Examples of the shape of the battery 100 include a coin type, a cylindrical type, a prismatic type, a sheet type, a button type, a flat type, and a stacked type.

### <Method for Manufacturing Battery>

The battery 100 of Embodiment 2 can be manufactured by, for example, preparing a material for the positive electrode, a material for the electrolyte layer, and a material for the negative electrode, and producing by a known method a stack composed of the positive electrode 11, the electrolyte layer 13, and the negative electrode 12 disposed in this order.

### Embodiment 3

Embodiment 3 will be described below. The description overlapping those of Embodiments 1 and 2 will be omitted as appropriate.

FIG. 2 is a cross-sectional view schematically showing the configuration of a battery 200 of Embodiment 3.

The battery 200 includes the positive electrode 11, the negative electrode 12, and the electrolyte layer 13. The electrolyte layer 13 is disposed between the positive electrode 11 and the negative electrode 12. The electrolyte layer 13 includes a first electrolyte layer 14 and a second electrolyte layer 15. The first electrolyte layer 14 is disposed between the positive electrode 11 and the negative electrode 12. The second electrolyte layer 15 is disposed between the first electrolyte layer 14 and the negative electrode 12. The first electrolyte layer 14 includes the solid electrolyte material 10. The solid electrolyte material 10 includes the solid electrolyte material of Embodiment 1 (first solid electrolyte material).

The first solid electrolyte material has a high oxidation resistance. Accordingly, the first electrolyte layer 14 can suppress oxidation of the solid electrolyte material included in the second electrolyte layer 15. Therefore, the battery 200 can have further enhanced charge and discharge characteristics.

The first electrolyte layer 14 may include a plurality of particles of the solid electrolyte material 10. In the first electrolyte layer 14, the plurality of solid electrolyte materials 10 may be in contact with each other.

In the battery 200, the solid electrolyte material included in the second electrolyte layer 15 may have a lower reduction potential than the solid electrolyte material 10 included in the first electrolyte layer 14 has. With the above configuration, it is possible to suppress reduction of the solid electrolyte material 10 included in the first electrolyte layer 14. Therefore, the battery 200 can have enhanced charge and discharge characteristics. For example, in the case where the first electrolyte layer 14 includes the first solid electrolyte material as the solid electrolyte material 10, the second electrolyte layer 15 may include a sulfide solid electrolyte in order to suppress reductive decomposition of the first solid electrolyte material.

### EXAMPLES

The present disclosure will be described below in detail with reference to examples and comparative examples.

### Example 1

### [Production of First Solid Electrolyte Material]

In a glove box in an argon atmosphere with a dew point of −60° C. or lower (hereinafter referred to as “in an argon atmosphere”), raw material powders LiF, NbF₅, and AlF₃ were weighed in a molar ratio of LiF:NbF₅:AlF3={6−(5−2x)b}:(1−x)b:xb, where x was 0.5 and b was 0.86. That is, the raw material powders LiF, NbF₅, and AlF₃ were weighed in a molar ratio of LiF:NbF₅:AlF₃=3.0:0.5:0.5. The ratio of the amount of substance Li to the sum of the amounts of substance of Nb and M, (Li/(Nb+M)), was 3. These raw material powders were subjected to a milling process in a planetary ball mill (Type P-7 manufactured by Fritsch GmbH) at 500 rpm for 12 hours. Thus, a powder of the first solid electrolyte material of Example 1 was obtained. The first solid electrolyte material of Example 1 had composition represented by Li_{3.0}Nb_{0.5}Al_{0.5}F_{7.0}.

### [Production of Battery]

In an argon atmosphere, the first solid electrolyte material of Example 1 and a positive electrode active material LiCoO₂ were prepared in a volume ratio of 40:60. These materials were mixed in an agate mortar. Thus, a positive electrode mixture was obtained.

Subsequently, LiCl and YCls were prepared in a molar ratio of LiCl:YCl₃=3:1. These materials were pulverized and mixed in a mortar. The resulting mixture was subjected to a milling process in a planetary ball mill at 500 rpm for 12 hours. Thus, a halide solid electrolyte having composition represented by LisYCl₆ (hereinafter referred to as “LYC”) (second solid electrolyte material) was obtained.

In an insulating cylinder having an inner diameter of 9.5 mm, the second solid electrolyte material (60 mg), the first solid electrolyte material (30 mg), and the positive electrode mixture (25.7 mg) were stacked in this order. The stack thus obtained was subjected to application of a pressure of 300 MPa to form a second electrolyte layer, a first electrolyte layer, and a positive electrode. That is, the first electrolyte layer made of the first solid electrolyte material was sandwiched between the second electrolyte layer made of the second solid electrolyte material and the positive electrode. The first electrolyte layer had a thickness of 150 μm, and the second electrolyte layer had a thickness of 450 μm.

Subsequently, metallic In (thickness: 200 μm) was stacked on the second electrolyte layer. The stack thus obtained was subjected to application of a pressure of 80 MPa to form a negative electrode.

Subsequently, current collectors made of stainless steel were attached to the positive electrode and the negative electrode, and current collector leads were attached to the current collectors.

Lastly, an insulating ferrule was used to block the inside of the insulating cylinder from the outside air atmosphere to hermetically seal the cylinder. Thus, the battery of Example 1 was obtained.

### Examples 2 to 9

### [Production of First Solid Electrolyte Material]

Raw material powders LiF, NbF₅, and AlF₃ were weighed in a molar ratio of LIF:NbF₅:AlF₃={6−(5−2x)b}:(1−x)b:xb. The values of x, b, and Li/(Nb+M) are shown in Table 1. After the milling process, only Examples 7 to 9 were subjected to an annealing process in an electric furnace at 125° C. for 6 hours. In the same manner as in Example 1 except for the above matters, the first solid electrolyte materials of Examples 2 to 9 were obtained.

### [Production of Battery]

Batteries of Examples 2 to 9 were obtained in the same manner as in Example 1, except that the first solid electrolyte materials of Examples 2 to 9 were used.

### Comparative Example 1

A battery of Comparative Example 1 was obtained in the same manner as in Example 1, except that LiBF₄ was used as the first solid electrolyte material of Comparative Example 1.

### Comparative Example 2

[Production of first solid electrolyte material]

Raw material powders LiF and NbF₅ were weighed in a molar ratio of LiF:NbF_{5=1.0:1.0}. In the same manner as in Example 1 except for the above matter, Li_{1.0}Nb_{1.0}F₆ was obtained as the first solid electrolyte material of Comparative Example 2.

### [Production of Battery]

A battery of Comparative Example 2 was obtained in the same manner as in Example 1, except that the first solid electrolyte material of Comparative Example 2 was used.

### Comparative Example 3

### [Production of First Solid Electrolyte Material]

Raw material powders LiF and NbF₅ were weighed in a molar ratio of LiF:NbF₅=3.0:1.0. In the same manner as in Example 1 except for the above matter, Li_{3.0}Nb_{1.0}F₈ was obtained as the first solid electrolyte material of Comparative Example 3.

### [Production of Battery]

A battery of Comparative Example 3 was obtained in the same manner as in Example 1, except that the first solid electrolyte material of Comparative Example 3 was used.

### (Evaluation of Ionic Conductivity)

FIG. 3 is a schematic diagram of a pressure-molding die used for evaluating the ionic conductivity of the first solid electrolyte materials.

A pressure-molding die 30 included an upper punch 31, a die 32, and a lower punch 33. The die 32 was made of polycarbonate, which is insulating. The upper punch 31 and the lower punch 33 were made of stainless steel, which is electronically conductive.

The pressure-molding die 30 shown in FIG. 3 was used to evaluate the ionic conductivity of the first solid electrolyte materials of the examples and the comparative examples by the following method.

In a dry atmosphere with a dew point of −30° C. or lower, the pressure-molding die 30 was filled with a powder 101 of the first solid electrolyte material. Inside the pressure-molding die 30, a pressure of 400 MPa was applied to the powder 101 of the first solid electrolyte material with the upper punch 31 and the lower punch 33.

While the pressure was applied, the upper punch 31 and the lower punch 33 were connected to a potentiostat (VSP-300 manufactured by Bio-Logic SAS) equipped with a frequency response analyzer. The upper punch 31 was connected to the working electrode and the potential measurement terminal. The lower punch 33 was connected to the counter electrode and the reference electrode. The impedance of the first solid electrolyte material was measured at room temperature (25° C.) by electrochemical impedance measurement.

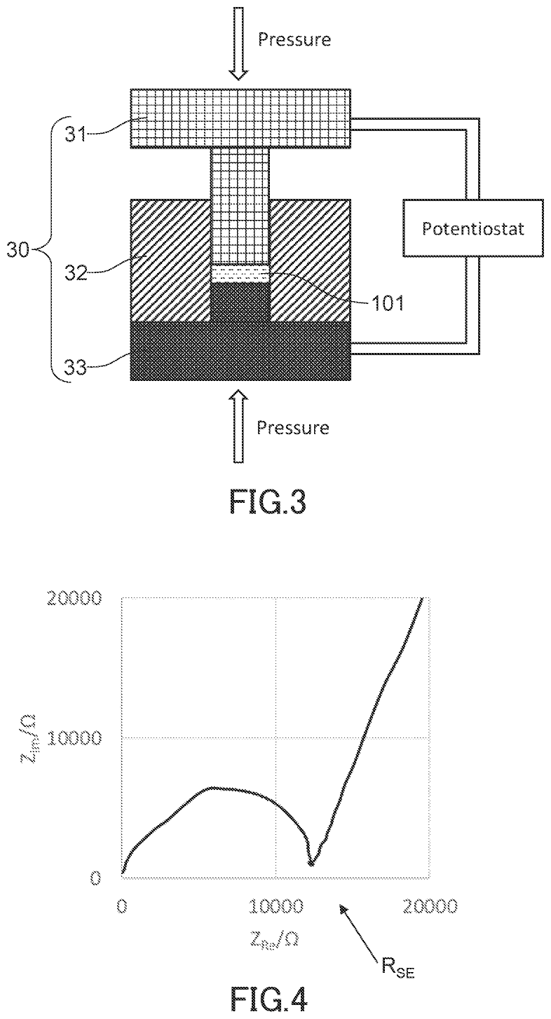

FIG. 4 is a graph showing a Cole-Cole plot obtained by the impedance measurement on the first solid electrolyte material of Example 1. In FIG. 4, the vertical axis represents the imaginary part of the impedance, and the horizontal axis represents the real part of the impedance.

In FIG. 4, a real value of the complex impedance at the measurement point where the absolute value of the phase of the complex impedance was smallest was defined as the resistance value of the first solid electrolyte material to ion conduction. For the real value, see an arrow R_{SE} shown in FIG. 4. The ionic conductivity was calculated from the resistance value by the following mathematical formula (2):

$$σ = {( {R}_{S E} \times S / t )}^{- 1} . \qquad Formula ( 2 )$$

In the mathematical formula (2), σ represents the ionic conductivity; S represents the contact area of the first solid electrolyte material with the upper punch 31 (equal to the cross-sectional area of the cavity of the die 32 in FIG. 3); R_{SE} represents the resistance value of the first solid electrolyte material in the impedance measurement; t represents the thickness of the first solid electrolyte material (equal to the thickness of the layer formed of the powder 101 of the first solid electrolyte material in FIG. 3).

The ionic conductivity of the first solid electrolyte material of Example 1 calculated by Formula (2) was 4.10×10⁻⁷ S/cm.

The first solid electrolyte materials of Examples 2 to 9 and Comparative Examples 1 to 3 were subjected to calculation of ionic conductivity as in Example 1. The results are shown in Table 1 below.

### (Charge and Discharge Test)

The batteries of the examples and the comparative examples were each subjected to a charge and discharge test under the following conditions to measure the charge capacity and discharge capacity in the initial state.

First, the battery was placed in a thermostatic chamber set at 85° C.

The battery was charged at a current density of 27 μA/cm² until the positive electrode reached a voltage of 3.6 V relative to the negative electrode. The current density is equivalent to 0.02 C rate relative to the theoretical capacity of the battery.

The battery was then discharged at a current density of 27 μA/cm² until the positive electrode reached a voltage of 1.9 V relative to the negative electrode. The current density is equivalent to 0.02 C rate relative to the theoretical capacity of the battery.

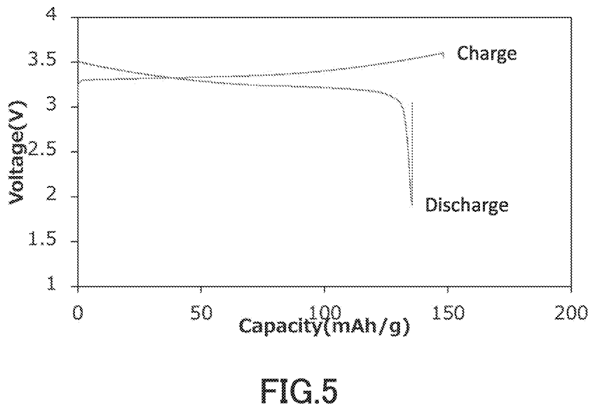

FIG. 5 is a graph showing the charge and discharge characteristics of the battery of Example 1 in the initial state. In FIG. 5, the vertical axis represents voltage, and the horizontal axis represents charge capacity or discharge capacity. The results of the charge and discharge test indicate that the battery of Example 1 had a discharge capacity of 1.90 mAh in the initial state. The batteries of Examples 2 to 9 also exhibited almost the same results as those of Example 1. In contrast, the batteries of Comparative Examples 1 to 3 failed in charge and discharge.

TABLE 1

| | First solid | | | | | Ionic | Annealing |
|---|---|---|---|---|---|---|---|
| | electrolyte material | | | | Li/ | conductivity | temperature |
| | composition formula | x | b | M | (Nb + M) | [S/cm] | [° C.] |
| Example 1 | Li₃Nb_{0.5}Al_{0.5}F₇ | 0.5 | 0.86 | Al | 3 | 4.10 × 10⁻⁷ | — |
| Example 2 | Li₆Nb_{0.8}Al_{1.2}F_{13.6} | 0.6 | 0.88 | Al | 3 | 2.70 × 10⁻⁶ | — |
| Example 3 | Li₆Nb_{0.7}Al_{1.3}F_{13.4} | 0.65 | 0.90 | Al | 3 | 2.48 × 10⁻⁶ | — |
| Example 4 | Li_{5.5}Nb_{0.8}Al_{1.2}F_{13.6} | 0.6 | 0.92 | Al | 2.75 | 2.80 × 10⁻⁶ | — |
| Example 5 | Li₅Nb_{0.8}Al_{1.2}F_{13.6} | 0.6 | 0.95 | Al | 2.5 | 1.50 × 10⁻⁶ | — |
| Example 6 | Li₆Nb_{0.9}Al_{1.1}F_{13.8} | 0.55 | 0.87 | Al | 3 | 7.45 × 10⁻⁷ | — |
| Example 7 | Li₃Nb_{0.5}Al_{0.5}F₇ | 0.5 | 0.86 | Al | 3 | 9.30 × 10⁻⁷ | 125 |
| Example 8 | Li₆Nb_{0.8}Al_{1.2}F_{13.6} | 0.6 | 0.88 | Al | 3 | 6.00 × 10⁻⁶ | 125 |
| Example 9 | Li₆Nb_{0.9}Al_{1.1}F_{13.8} | 0.55 | 0.87 | Al | 3 | 1.21 × 10⁻⁶ | 125 |
| Comparative | LiBF₄ | — | — | — | 1 | 6.70 × 10⁻⁹ | — |
| Example 1 | | | | | | | |
| Comparative | LiNbF₆ | — | — | — | 1 | 6.55 × 10⁻⁸ | — |
| Example 2 | | | | | | | |
| Comparative | Li₃NbF₈ | — | — | — | 3 | 3.03 × 10⁻¹¹ | — |
| Example 3 | | | | | | | |

### <<Consideration>>

The first solid electrolyte materials of Examples 1 to 9 had a high ionic conductivity of 1×10⁻⁷ S/cm or more at room temperature. In contrast, the first solid electrolyte materials of Comparative Examples 1 to 3 had an ionic conductivity of less than 1×10⁻⁷ S/cm.

As evident from comparing Examples 2 to 4 and 8 with Examples 1, 6, 7, and 9, a tendency was particularly observed for the first solid electrolyte material to have an enhanced ionic conductivity by satisfying 0.88≤b≤0.92.

The first solid electrolyte material of Example 1 and the first solid electrolyte material of Example 7 had the same composition. The first solid electrolyte material of Example 2 and the first solid electrolyte material of Example 8 had the same composition. The first solid electrolyte material of Example 6 and the first solid electrolyte material of Example 9 had the same composition. As evident from comparing Examples 1, 2, and 6 with Examples 7, 8, and 9 respectively, a tendency was observed for the first solid electrolyte material to have an enhanced ionic conductivity by including a 125° C. annealing process in the production of the first solid electrolyte material.

The batteries of Examples 1 to 9 exhibited excellent charge and discharge characteristics in the charge and discharge test. In contrast, the batteries of Comparative Examples 1 to 3 failed in both charge and discharge.

Using, instead of Al, at least one selected from the group consisting of Be, Mg, Ca, Sr, Ba, Sc, Y, Ga, In, Zr, and Sn, for example, Mg, Ca, Y, or Zr also promises the same effects as those in using Al. This is because an element having a formal valence of 2 or more and 4 or less and having a high ionicity has properties similar to those of Al.

As demonstrated by the above examples, according to the present disclosure, it is possible to provide a novel halide solid electrolyte material having a high oxidation resistance and a high ionic conductivity.

### INDUSTRIAL APPLICABILITY

The battery of the present disclosure can be used as, for example, an all-solid-state lithium-ion secondary battery.

What is claimed is:

1. A solid electrolyte material comprising Li, Nb, M, and F, wherein the M is at least one selected from the group consisting of Be, Mg, Ca, Sr, Ba, Sc, Y, Al, Ga, In, Zr, and Sn.

2. The solid electrolyte material according to claim 1, wherein
a ratio of an amount of substance of the Li to a sum of amounts of substance of the Nb and the M is 2.2 or more and 3.3 or less.

3. The solid electrolyte material according to claim 1, being represented by the following composition formula (1): 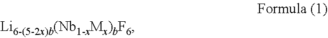
wherein
in the composition formula (1),
the M is Al, and
0<x<1 and 0<b≤1.2 are satisfied.

4. The solid electrolyte material according to claim 3, wherein
in the composition formula (1),
0.40≤x≤0.80 is satisfied.

5. The solid electrolyte material according to claim 3, wherein
in the composition formula (1),
0.80≤b≤1.10 is satisfied.

6. A battery comprising:
a positive electrode;
a negative electrode; and
an electrolyte layer disposed between the positive electrode and the negative electrode, wherein
at least one selected from the group consisting of the positive electrode, the negative electrode, and the electrolyte layer includes the solid electrolyte material according to claim 1.

7. The battery according to claim 6, wherein
the electrolyte layer includes a first electrolyte layer and a second electrolyte layer,
the first electrolyte layer is disposed between the positive electrode and the negative electrode,
the second electrolyte layer is disposed between the first electrolyte layer and the negative electrode, and
the first electrolyte layer includes the solid electrolyte material.
